(19) United States
(12) Patent Application Publication
(10) Pub. No.: US 2015/0286723 A1
(43) Pub. Date: Oct. 8, 2015

(54) IDENTIFYING DOMINANT ENTITY CATEGORIES

(71) Applicant: MICROSOFT CORPORATION, Redmond, WA (US)

(72) Inventors: WALTER SUN, Bellevue, WA (US); HUNG-AN CHANG, Bellevue, WA (US); JINGFENG LI, Issaquah, WA (US); ANN LEE, Cambridge, MA (US)

(73) Assignee: MICROSOFT CORPORATION, Redmond, WA (US)

(21) Appl. No.: 14/246,905

(22) Filed: Apr. 7, 2014

(51) Int. Cl. G06F 17/30

(52) U.S. Cl. CPC G06F 17/30864; G06F 17/3053

(57) ABSTRACT

Systems, methods, and computer-readable storage media are provided for identifying dominant entity categories associated with target entities. A target entity is received and plural data sources are utilized to determine entity categories of which the target entity is a member and an initial confidence score for each of the entity categories. Each initial confidence score represents the likelihood that the associated entity category is a dominant category for the target entity. At least one data source includes information pertaining to plural entities arranged in a graph-based ontology that includes identifiers of respective entity categories of which the subject entities are members. Graph-based confidence score propagation is then utilized to incorporate information regarding entities determined to be related to the target entity and accolades associated with the target entity to alter the initial confidence scores provided for various entity categories of which the target entity is a member.

### BACKGROUND

In recent years, many online search features have transitioned from being keyword-based, from simple text strings, to being entity-based. In this context, entities are instances of abstract concepts and objects, including people, events, locations, businesses, movies, and the like. Entities generally include one or more attributes or characteristics associated therewith, each attribute having at least one associated attribute value. Entities having common attributes or characteristics may be organized into entity categories that aid in establishing commonalities and inter-relationships between entities. Some search engines, such as the BING search engine available from Microsoft Corporation of Redmond, Wash., are capable of powering scenarios to explicitly search for a specific entity instead of just a text description of the entity. For instance, such a search engine may be capable of recognizing “John Doe” as an entity and thus of providing a richer search result experience for specifically this entity over the search experience it could provide for a textual query involving two words “john” and “doe.”

One key challenge in the realm of entity-based search is that many entities are members of multiple entity categories. For instance, the entity “Michael Jordan” may be a member of plural entity categories including “basketball players,” “film actors,” and “music artists.” Upon receipt of a query for the entity “Michael Jordan,” it is challenging for a search engine to determine which of the plural entity categories is dominant for the queried entity (i.e., “Michael Jordan”) and thus to provide the most accurate and complete information for many applications and analyses, for instance, search result determination, entity display, query understanding, data group ranking, and user experience analyses, to name a few.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for identifying dominant entity categories associated with target entities. A target entity is received and a plurality of data sources is utilized to determine entity categories of which the target entity is a member, as well as an initial confidence score for each of the entity categories. Each initial confidence score represents the likelihood that the associated entity category is a dominant entity category for the target entity. At least one of the plurality of data sources includes information pertaining to a plurality of entities arranged in a graph-based ontology that includes, among other information items, identifiers of respective entity categories of which the subject entities are members. Graph-based confidence score propagation is then utilized to incorporate information regarding entities determined to be related to the target entity and accolades associated with the target entity to confirm, refute, and/or refine the initial confidence scores provided for various entity categories of which the target entity is a member.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for identifying dominant entity categories associated with target entities, in accordance with an embodiment of the present invention;

FIG. 4 is a flow diagram showing another exemplary method for identifying dominant entity categories associated with target entities, in accordance with an embodiment of the present invention;

FIG. 5 is a flow diagram showing yet another exemplary method for identifying dominant entity categories associated with target entities, in accordance with an embodiment of the present invention; and

FIG. 6 is a schematic diagram illustrating graph-based confidence score propagation between a target entity and a related entity, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for categorizing entities and identifying dominant entity categories associated therewith. Entity categorization involves identifying entities having common attributes or characteristics and organizing them into higher level entity categories that aid in establishing commonalities and interrelationships between entities. Exemplary entity categories include, without limitation: “actors” (e.g., persons whose main professions are movie actors, television actors, theater actors, etc.), “athletes” (e.g., persons whose main professions are basketball players, baseball players, soccer players, players of all kinds of sports, etc.), and “attractions” (e.g., tourist spots including museums, landmarks, national parks, etc.).

Some of the main challenges for entity categorization methods are: (1) every entity is unique and has its own characteristics, thus identifying commonalities may be challenging; and (2) category definitions may change with time or with different applications and it is often cost-prohibitive to collect such ever-changing definitions and re-train models accordingly. Embodiments of the present invention address both of these challenges.

In accordance with embodiments hereof, in an off-line process, a target entity is received, and a plurality of data sources is utilized to determine entity categories of which the target entity is a member. Utilizing a plurality of data sources aids in capturing the uniqueness of each entity. In embodiments, at least one of the plural data sources includes information pertaining to a plurality of entities arranged in a graph-based ontology. The graph-based ontology represents the information about the entities using a common vocabulary to denote, at least, entity categories, category properties, entity attributes or characteristics, and interrelationships of the entities, entity categories, etc. The multiple data sources are also utilized to determine an initial confidence score for each of the entity categories. Each initial confidence score represents the likelihood that the associated entity category is a dominant entity category for the target entity, that is, an entity category about which a user querying the target entity would most likely desire information. Graph-based confidence score propagation (as more fully described below) is utilized to incorporate information regarding entities determined to be closely related to the target entity and accolades (e.g., titles, awards, championships, etc.) associated with the target entity to confirm, refute, and/or refine the initial confidence scores provided for various entity categories of which the target entity is a member. This two-stage process provides an unsupervised framework in which model training is not required and new category definitions can be easily addressed. Further, for new applications, system developers can design the mapping between scored and ranked category types and the category types that best suit their need.

Accordingly, one embodiment of the present invention is directed to one or more computer-readable storage media storing computer-useable instructions that, when used by one or more computing devices, cause the one or more computing devices to perform a method for identifying dominant entity categories associated with target entities. The method includes receiving a target entity and assigning an initial confidence score for the target entity to two or more entity categories of which the target entity is a member. Each initial confidence score represents the likelihood that the respective entity category is dominant for the target entity. The method further includes determining, by performing graph-based confidence score propagation (as more fully described below), a correlation between the two or more entity categories of which the target entity is a member and at least one entity category of which a related entity that is closely related to the target entity is a member. Still further, the method includes altering the initial confidence score for at least one of the two or more entity categories of which the target entity is a member based upon the correlation.

In another embodiment, the present invention is directed to a method being performed by one or more computing devices including at least one processor, the method for identifying dominant entity categories associated with target entities. The method includes receiving a target entity. Using multiple data sources, at least one of which includes information pertaining to a plurality of entities arranged in a graph-based ontology, the information including entity categories of which each of the plurality of entities respectively is a member, the method further includes determining that the target entity is a member of two or more of the plurality of entity categories and assigning an initial confidence score for the target entity to each of the two or more entity categories of which the target entity is a member. Each initial confidence score represents the likelihood that the respective entity category is dominant for the target entity. The method further includes identifying at least one related entity that is closely related to the target entity, determining at least on entity category of the plurality of entity categories of which the at least one related entity is a member, and altering the initial confidence score for at least one of the two or more entity categories of which the target entity is a member based upon at least one correlation between the two or more entity categories of which the target entity is a member and the at least one entity category of which the at least one related entity is a member.

In yet another embodiment, the present invention is directed to a system including a search engine having one or more processors and one or more computer-readable storage media; a first data source coupled with the search engine, the first data source including a plurality of entities associated therewith, each having at least one associated entity category; and a second data source coupled with the search engine. The search engine is configured to receive a target entity. Utilizing the first and second data sources, the search engine further is configured to determine that the target entity is a member of two or more of the plurality of entity categories and assign an initial confidence score for the target entity to each of the two or more entity categories of which the target entity is a member, each initial confidence score representing a likelihood that the respective entity category is dominant for the target entity. Still further, the search engine is configured to (1) identify at least one related entity that is closely related to the target entity, (2) determine, by performing graph-based confidence score propagation (as more fully described below) a correlation between the two or more entity categories of which the target entity is a member and at least one entity category of which the at least one related entity is a member, and (3) adjust the initial confidence score for at least one of the two or more entity categories of which the target entity is a member based upon the correlation.

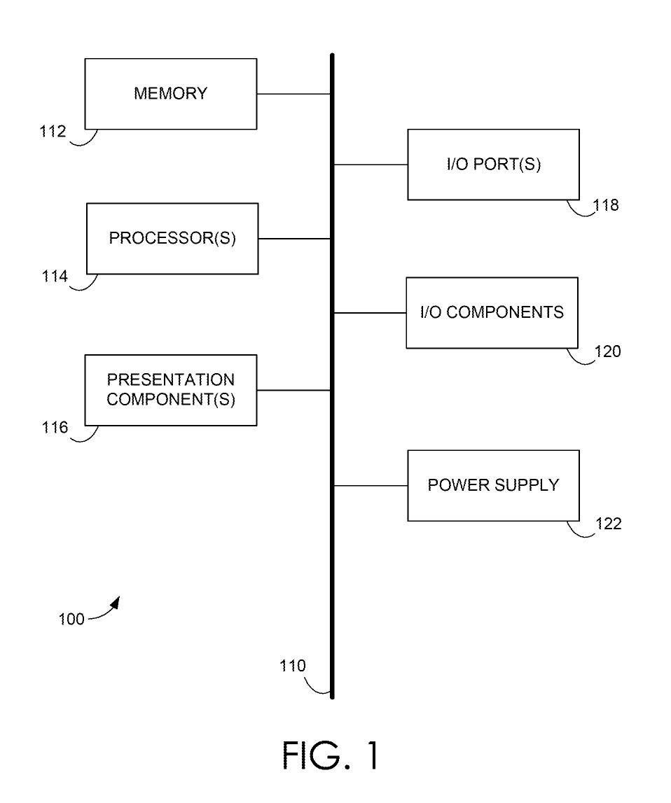

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller (such as a stylus, keyboard, and mouse) or a natural user interface (NUI), etc.

The NUI processes gestures (e.g., hand, face, body, etc.), voice, or other physiological inputs generated by a user. These inputs may be interpreted as queries, requests for selecting URLs, or requests for interacting with a URL included as a search result. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “search engine” is used herein, it will be recognized that this term may also encompass a server, a Web browser, a set of one or more processes distributed on one or more computers, one or more stand-alone storage devices, a set of one or more other computing or storage devices, a combination of one or more of the above, and the like.

As previously mentioned, embodiments of the present invention are generally directed to systems, methods, and computer-readable storage media for identifying dominant entity categories associated with target entities. In an off-line process, a target entity is received and a plurality of data sources is utilized to determine entity categories of which the target entity is a member. At least one of the plural data sources includes information pertaining to a plurality of entities arranged in a graph-based ontology. The graph-based ontology represents the information about the entities using a common vocabulary to denote, at least, entity categories, category properties, entity attributes or characteristics, and interrelationships of the entities, entity categories, etc. The multiple data sources are also utilized to determine an initial confidence score for each of the entity categories. Each initial confidence score represents the likelihood that the associated entity category is a dominant entity category for the target entity, that is, an entity category about which a user querying the target entity would most likely desire information. Graph-based confidence score propagation (as more fully described below) is utilized to incorporate information regarding entities determined to be closely related to the target entity and accolades (e.g., titles, awards, championships, etc.) associated with the target entity to confirm, refute, and/or refine the initial confidence scores provided for various entity categories of which the target entity is a member

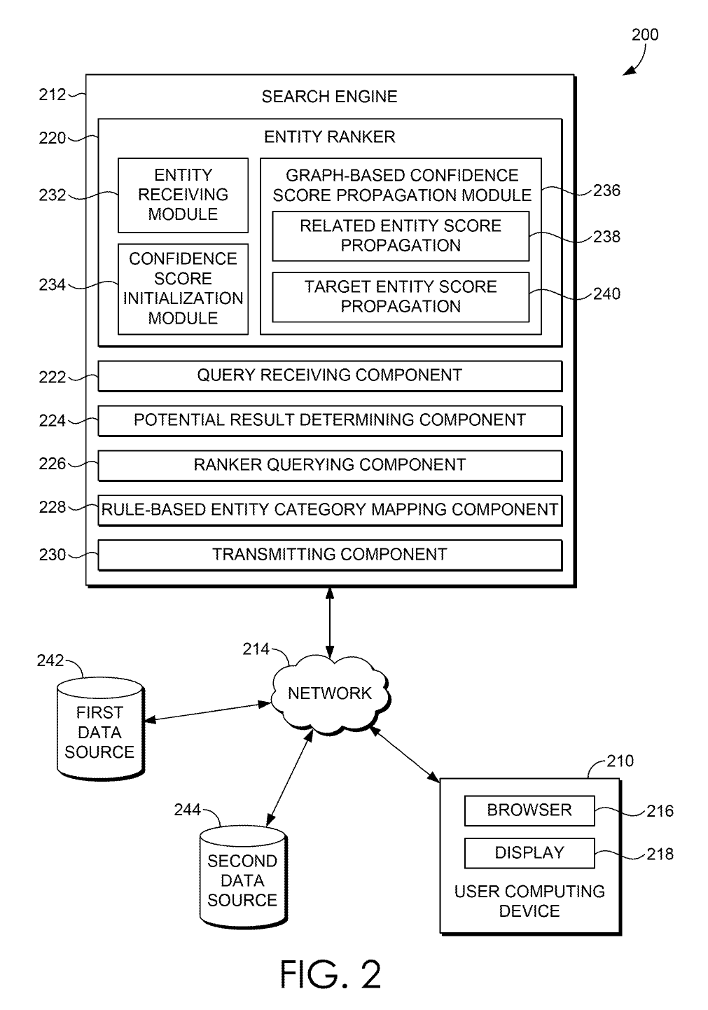

Referring now to FIG. 2, a block diagram is provided illustrating an exemplary computing system 200 in which embodiments of the present invention may be employed. Generally, the computing system 200 illustrates an environment in which, in an off-line process, target entities may be categorized and dominant entity categories identified and, in an on-line process, relevant search results associated with a dominant entity category for a queried target entity may be provided. Among other components not shown, the computing system 200 generally includes a user computing device 210 and a search engine 212 in communication with one another via a network 214. The network 214 may include, without limitation, one or more local area networks (LANs) and/or wide area networks (WANs). Such networking environments are commonplace in offices, enterprise-wide computer networks, intranets and the Internet. Accordingly, the network 214 is not further described herein.

It should be understood that any number of user computing devices 210 and/or search engines 212 may be employed in the computing system 200 within the scope of embodiments of the present invention. Each may comprise a single device/interface or multiple devices/interfaces cooperating in a distributed environment. For instance, the search engine 212 may comprise multiple devices and/or modules arranged in a distributed environment that collectively provide the functionality of the search engine 212 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the user computing device 210, the search engine 212, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines and/or user computing devices. By way of example only, the search engine 212 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 includes a browser 216 and a display 218. The browser 216, among other things, is configured to render search engine home pages (or other online landing pages) and search engine results pages (SERPs), in association with the display 218 of the user computing device 210. The browser 216 is further configured to receive user input of requests for various web pages (including search engine home pages), receive user input search queries (generally input via a user interface presented on the display 218 and permitting alpha-numeric and/or textual input into a designated search input region) and to receive content for presentation on the display 218, for instance, from the search engine 212. It should be noted that the functionality described herein as being performed by the browser 216 may be performed by any other application, application software, user interface, or the like capable of rendering Web content. It should further be noted that embodiments of the present invention are equally applicable to mobile computing devices and devices accepting touch and/or voice input. Any and all such variations, and any combination thereof, are contemplated to be within the scope of embodiments of the present invention.

The search engine 212 of FIG. 2 is configured to, among other things, receive search queries, identify dominant entity categories for queried target entities, and provide search results relevant to a target entity by virtue of the dominant entity categories in response thereto. As illustrated, the search engine 212 includes an entity category ranker 220, a query receiving component 222, a potential search result determining component 224, an entity category ranker querying component 226, a rule-based entity category mapping component 228, and a transmitting component 230. The illustrated search engine 212 also has access to a first data source 242 and a second data source 244. The first data source 242 is configured to store information pertaining to a plurality of entities arranged in a graph-based ontology that represents the information about the entities using a common vocabulary to denote, at least, entity categories, category properties, entity attributes or characteristics, and interrelationships of the entities, entity categories, etc. Thus, the graph-based ontology includes, by way of example and not limitation, an identification of the entity categories of which each of the plurality of entities respectively is a member. The second data source 244 also includes information pertaining to plural entities, such information being organized in any desired arrangement. In one embodiment, the second data source 244 is WIKIPEDIA in which the information pertaining to the plurality of entities is arranged in a set of documents.

In embodiments, one or both of the first data source 242 and the second data source 244 are configured to be searchable for one or more of the items stored in association therewith. It will be understood and appreciated by those of ordinary skill in the art that the information stored in association with the first and second data sources 242, 244 may be configurable and may include any information relevant to entities, that is, instances of abstract concepts and objects, including people, events, locations, businesses, movies, and the like. One or both of the data sources 242, 244 may also include an identification of entity categories, entity category common characteristics, entity attributes or characteristics, entity attribute values, and the like. The content and volume of such information are not intended to limit the scope of embodiments of the present invention in any way. Further, though each data source 242, 244 is illustrated as a single, independent component, the first and second data sources 242, 244 may, in fact, each be a plurality of storage devices, for instance a database cluster, portions of which may reside in association with the search engine 212, the user computing device 210, another external computing device (not shown), and/or any combination thereof.

The entity category ranker 220 of the search engine 212 is configured to identify or determine the relevant entity categories of which each encountered entity is a member; assign initial confidence scores to the relevant entity categories; utilize information pertaining to entities related to a target entity and accolades received by a target entity to confirm, refute, and/or otherwise adjust the initial confidence scores assigned; and rank the determined entity categories for each target entity in accordance with the altered confidence scores. As illustrated, the entity category ranker 220 includes an entity receiving module 232, a confidence score initialization module 234, and a graph-based confidence score propagation module 236.

The entity receiving module 232 is configured to receive, in an off-line process, target entities for which categorization is desired. For purposes of illustration, suppose the target entity “Michael Jordan” is received by the entity receiving module 232.

The confidence score initialization module 234 is configured to receive, from the entity receiving module 232, the target entity and to determine if the target entity is a member of one or more entity categories. In embodiments, a finite set of potential entity categories is available from which the confidence score initialization module 234 may select the potential entity categories. In embodiments, absent appropriate or sufficient matches to a finite set of potential entity categories, or in addition thereto, previously undefined entity categories may be assigned to a target entity. Any and all such variations, and any combination thereof, are contemplated to be within the scope of embodiments hereof.

Potential entity categories are assigned utilizing both of the first and second data sources 242, 244. As the first data source is configured to store information pertaining to a plurality of entities arranged in a graph-based ontology that represents the information about the entities using a common vocabulary, the graph-based ontology includes an identification of the already-identified entity categories of which each of the plurality of entities is a member. As the second data source 244 includes information pertaining to the plural entities organized in any desired arrangement, extraction of relevant information pertaining to entity categories may be performed utilizing any information extraction method known to those of ordinary skill in the art. In one embodiment, the second data source 244 includes information organized as a series of documents and the information extraction takes place, at least in part, via term frequency-inverse document frequency (TF-IDF) analysis which provides a score that is a numerical statistic reflecting how important a particular word is to a document. When the TF-IDF score is high, the number of times that the particular word appears in the document is high and the/or the number of documents that contain the word is low. Such analysis may be conducted on entire documents, first paragraphs, headings, or any other document portion desired.

If it is determined by the confidence score initialization module 234 that a target entity is a member of only a single entity category, such entity category is determined to be the dominant entity category for the target entity. If, however, the target entity is determined to be a member of multiple entity categories, the confidence score initialization module 234 further is configured to assign an initial confidence score for the target entity to two or more entity categories of which the target entity is a member. The initial confidence scores are assigned utilizing both the first data source 242 and the second data source 244 and represent the likelihood that the respective entity category is dominant for the target entity. Such determination may be made utilizing any information available to the confidence score initialization module 234 including, without limitation, information stored in association with the first data source 242, the second data source 244, and prior search logs that include information associated with a plurality of system users.

Returning to the above example, suppose that upon receipt of the target entity “Michael Jordan,” and consultation of the first data source 242 and the second data source 244, it is determined (by the confidence score initialization module 234) that the entity “Michael Jordan” is a member of the entity categories “sports.pro_athlete,” “music.artist,” “film.actor,” “basketball.player,” “sports.team_owner,” and “baseball.player.” Suppose upon consultation of at least the first data source 242 and the second data source 244 it is further determined that there is a 40% likelihood or probability that the entity category “basketball.player,” is the dominant entity category for the target entity, a 40% likelihood that the dominant entity category is “film.actor,” and a 20% likelihood that the dominant entity category is “music.artist.”

The graph-based confidence score propagation module 236 is configured to receive the initial confidence scores assigned by the confidence score initialization module 234, determine one or more related entities that is closely related to the target entity, determine one or more accolades received by the target entity (if applicable), and adjust the initial confidence scores associated with the two or more entity categories as necessary. In this regard, the related entity score propagation module 238 is configured to identify or determine one or more entities that are closely related to the target entity. Many methods currently exist in the art for identifying related entities that may be appropriate for use with the present invention. Accordingly, determination of related entities is not further described herein.

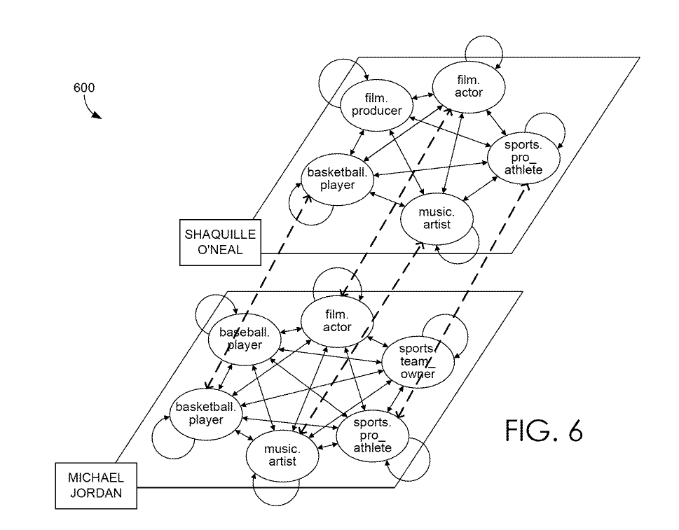

Once identified, the related entity score propagation module 238 is configured to identify one or more entity categories of which any identified/determined related entities are a member. Utilizing graph-based confidence score propagation, the initial confidence scores associated with the two or more entity categories of which the target entity is a member may be bolstered, confirmed, refuted, or otherwise adjusted to reflect the correlation between the target entity and the one or more related entities. Returning to the above-described example, suppose the entity “Shaquille O'Neal” is determined to be a related entity to the entity “Michael Jordan.” Further suppose that the entity categories “basketball.player,” “film.producer,” “film.actor,” “music.artist,” and “sports.pro_athlete” are determined to be entity categories of which the entity “Shaquille O'Neal” is a member. Utilizing graph-based confidence score propagation, it can be determined that the target entity and the related entity have the entity categories “basketball.player,” “film.actor,” “sports.pro_athlete,” and “music.artist” in common. Such commonality may be utilized to initially determine that the “Michael Jordan” and “Shaquille O'Neal” are related entities and/or may also be utilized to narrow down the categories of which the target entity “Michael Jordan” is a member that are viable candidates to be the dominant entity category. The graph-based confidence score propagation of “Michael Jordan” with related entity “Shaquille O'Neal” is illustrated in the schematic diagram 600 of FIG. 6.

Completing the above graph-based confidence score propagation for a target entity with respect to a plurality of other entities to either determine relationships there between and/or to adjust likelihoods that certain entity categories are dominant entity categories is utilized to determine an altered confidence score for at least one of the two or more entity categories of which the target entity is a member. A further method for altering the initial confidence score is performed by the target entity confidence score propagation component 240 of the graph-based confidence score propagation module 236. The target entity confidence score propagation component 240 examines information pertaining to accolades (e.g., awards, championships, titles, etc.) received by the target entity to determine if an initial confidence score assigned to an entity category should be adjusted. For instance, in the above example, if the entity “Michael Jordan” has received a number of basketball awards, titles, championships, etc., the likelihood that the entity category “basketball.player” is the dominant entity category for the target entity “Michael Jordan” is increased. Target entity confidence score propagation is illustrated in FIG. 6 by the semi-circular arrows that originate and terminate at the nodes representing the various entity categories.

In view of the information gleaned from the related entity confidence score propagation component 238 and the target entity confidence score propagation component 240, the graph-based confidence score propagation module 236 is further configured to adjust (e.g., confirm, alter, increase, decrease, etc.) the initial confidence scores for the two or more entity categories of which the target entity is a member. Thus, suppose that given the relationships of the entity “Michael Jordan” to a number of related entities that are also members of the entity category “basketball.player” and the accolades received by the entity “Michael Jordan” that are basketball related, the graph-based confidence score propagation module 236 may increase the initial confidence score for the entity category “basketball.player” from 40% to 80%.

The entity category ranker 220 further may be configured to rank relative adjusted and/or initial confidence scores with respect to one another. One can imagine that in many instances, far too many applicable entity categories may surface for a given target entity making it unpractical, if not impossible, to provide information pertaining to all entity categories of which the target entity is a member. Additionally, one can imagine that users querying a particular target entity often have only a single entity category in mind for which they desire information. Accordingly, knowing a relative rank of the confidence scores assigned to various entity categories may be useful in many circumstances.

The above-described entity category ranker 220 and the process of assigning, altering, and ranking entity category confidence scores is an off-line process designed to support maintenance of relevant entity category information. As previously stated, however, the search engine 212 is further configured, in an on-line process, to receive search queries and provide search results relevant to dominant entity categories in response thereto. In this regard, the query receiving component 222 of the search engine 212 is configured to receive a search query, for instance, from the user computing device 210, the search query including one or more target entities and/or terms that are associated with a target entity. Upon receipt of a search query, the potential result determining component 224 of the search engine 212 is configured to determine a plurality of search results that are relevant to the received query.

In many instances, the determined search results will include results relevant to multiple entity categories but most likely not relevant to the user's query intent. As such, the ranker querying component 226 of the search engine 212 is configured to query the entity category ranker 220 to identify the relative confidence scores of the entity categories for which potential search results were identified. The rule-based entity category mapping component 228 of the search engine 212 is configured to apply one or more rules to the relative confidence scores to determine the most appropriate search results to display. For instance, in the above-described example, since it was determined by the entity category ranker 220 that there is an 80% chance that the entity category “basketball.player” is the dominant entity category for the target entity “Michael Jordan,” upon receipt of a query for which “Michael Jordan” is identified as the subject, the rule-based entity category mapping component 228 may determine that results pertaining to Michael Jordan the basketball player will be displayed more prominently than, for instance, those pertaining to Michael Jordan the film actor.

The transmitting component 230 of the search engine 212 is configured to transmit the determined search results pertaining to the appropriate entity categories for presentation, for instance, in association with the display 218 of the user computing device 210.

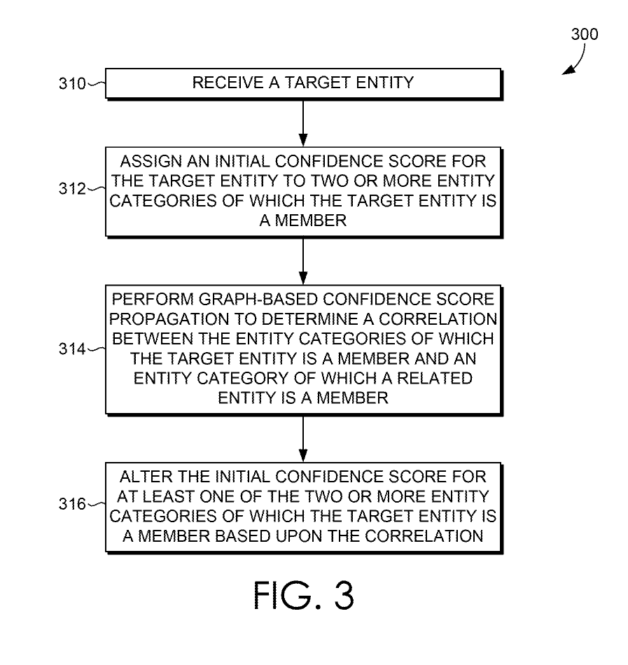

Turning now to FIG. 3, a flow diagram is illustrated showing an exemplary method 300 for identifying dominant entity categories associated with target entities, in accordance with an embodiment of the present invention. As indicated at block 310, a target entity is received in an off-line process, for instance, by the entity receiving module 232 of the entity category ranker 220 of FIG. 2. As indicated at block 312, an initial confidence score for the target entity is assigned to two or more entity categories of which the target entity is member, for instance, utilizing the confidence score initialization module 234 of the entity category ranker 220 of FIG. 2. Each initial confidence score represents the likelihood that the respective entity category is dominant for the target entity, that is, that the respective entity category is a category associated with the target entity about which a user querying the target entity would most likely desire information. As indicated at block 314, graph-based confidence score propagation is performed (e.g., utilizing the related entity score propagation component 238 of the graph-based confidence score propagation module 236 of the entity category ranker 220 of FIG. 2) to determine a correlation between the two or more entity categories of which the target entity is a member and at least one entity category of which at least one entity that is closely related to the target entity is a member. Based upon the determined correlation, the initial confidence score for at least one of the two or more entity categories of which the target entity is a member is altered (e.g., confirmed, refuted, and/or refined). This is indicated at block 316.

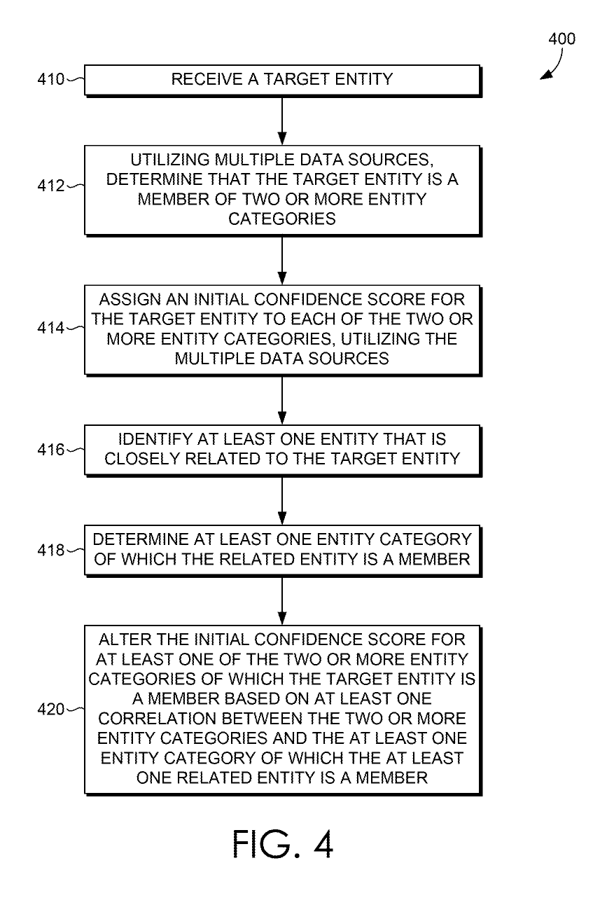

With reference to FIG. 4, a flow diagram is illustrated showing an exemplary method 400 for identifying dominant entity categories associated with target entities, in accordance with an embodiment of the present invention. As indicated at block 410, a target entity is received in an off-line process, for instance, by the entity receiving module 232 of the entity category ranker 220 of FIG. 2. As indicated at block 412, multiple data sources (for instance, first data source 242 and second data source 244 of FIG. 2) are utilized to determine that the target entity is a member of two or more entity categories. At least one of the multiple data sources includes information pertaining to a plurality of entities arranged in a graph-based ontology, the information including entity categories of which each of the plurality of entities (including the target entity) is a member. As indicated at block 414, utilizing the multiple data sources, an initial confidence score for the target entity is assigned to each of the two or more entity categories of which the target entity is member, for instance, utilizing the confidence score initialization module 234 of the entity category ranker 220 of FIG. 2. Each initial confidence score represents the likelihood that the respective entity category is dominant for the target entity.

With continued reference to FIG. 4, at least one entity that is closely related to the target entity is identified, as indicated at block 416. At least one entity category of which the related entity is a member also is determined or identified, as indicated at block 418. As indicated at block 420, the initial confidence score for at least one of the two or more entity categories of which the target entity is a member is altered (e.g., confirmed, refuted, and/or refined) based upon at least one correlation between the two or more entity categories of which the target entity is a member and the at least one entity category of which the at least one related entity is a member. This may be done, for instance, utilizing the graph-based confidence score propagation module 236 of the entity category ranker 220 of FIG. 2.

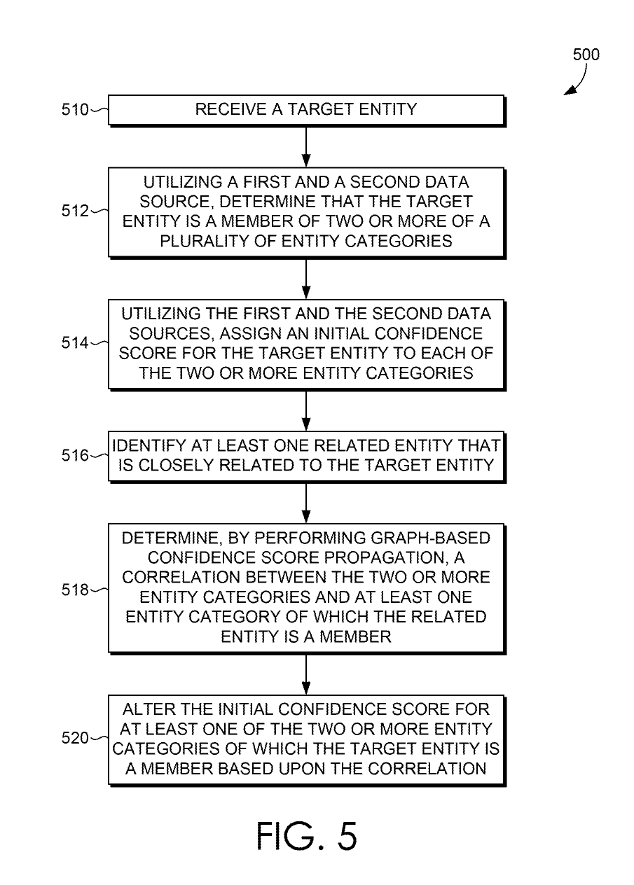

Turning now to FIG. 5, a flow diagram is illustrated showing another exemplary method 500 for identifying dominant entity categories associated with target entities, in accordance with an embodiment of the present invention. As indicated at block 510, a target entity is received, for instance, by the entity receiving module 232 of the entity category ranker 220 of FIG. 2. As indicated at block 512, a first and a second data source (for instance, first data source 242 and second data source 244 of FIG. 2) are utilized to determine that the target entity is a member of two or more of a plurality of entity categories. At least one of the first and second data sources includes information pertaining to the plurality of entities (including the target entity) arranged in a graph-based ontology, the information including entity categories of which each of the plurality of entities is a member. As indicated at block 514, utilizing the first and second data sources, an initial confidence score for the target entity is assigned to each of the two or more entity categories of which the target entity is member, for instance, utilizing the confidence score initialization module 234 of the entity category ranker 220 of FIG. 2. Each initial confidence score represents the likelihood that the respective entity category is dominant for the target entity.

As indicated at block 516, at least one entity that is closely related to the target entity is determined. As indicated at block 518, graph-based confidence score propagation is performed (e.g., utilizing the related entity score propagation component 238 of the graph-based confidence score propagation module 236 of the entity category ranker 220 of FIG. 2) to determine a correlation between the two or more entity categories of which the target entity is a member and at least one entity category of which at least one entity that is closely related to the target entity is a member. Based upon the determined correlation, the initial confidence score for at least one of the two or more entity categories of which the target entity is a member is altered (i.e., confirmed, refuted, and/or refined). This is indicated at block 520.

As can be understood, embodiments of the present invention provide systems, methods, and computer-readable storage media for, among other things, identifying dominant entity categories associated with target entities. A target entity is received and a plurality of data sources is utilized to determine entity categories of which the target entity is a member, as well as an initial confidence score for each of the entity categories. Each initial confidence score represents the likelihood that the associated entity category is a dominant entity category for the target entity. At least one of the plurality of data sources includes information pertaining to a plurality of entities arranged in a graph-based ontology that includes, among other information items, identifiers of respective entity categories of which the subject entities are members. Graph-based score propagation is then utilized to incorporate information regarding entities determined to be related to the target entity and accolades associated with the target entity to confirm, refute, and/or refine the initial confidence scores provided for various entity categories of which the target entity is a member.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIG. 3, 400 of FIG. 4, and 500 of FIG. 5 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for identifying dominant entity categories associated with target entities, the method comprising:
receiving a target entity;
assigning an initial confidence score for the target entity to two or more entity categories of which the target entity is a member, each initial confidence score representing a likelihood that the respective entity category is dominant for the target entity;
determining, by performing graph-based confidence score propagation, a correlation between the two or more entity categories of which the target entity is a member and at least one entity category of which at least one related entity that is closely related to the target entity is a member; and
altering the initial confidence score for at least one of the two or more entity categories of which the target entity is a member based upon the correlation.

2. The one or more computer-readable storage media of claim 1, wherein the method further comprises determining, utilizing multiple data sources, that the target entity is a member of the two or more entity categories, the entity categories being derived from one of the multiple data sources that includes information pertaining to a plurality of entities arranged in a graph-based ontology, the information including entity categories of which each of the plurality of entities respectively is a member.

3. The one or more computer-readable storage media of claim 2, wherein assigning the initial confidence score for the target entity to two or more entity categories of which the target entity is a member comprises assigning the initial confidence score utilizing the multiple data sources.

4. The one or more computer-readable storage media of claim 1, wherein the graph-based confidence score propagation further includes determining the target entity enjoys one or more accolades commonly associated with a certain entity category of the two or more entity categories of which the target entity is a member and altering the initial confidence score for the certain entity category accordingly.

5. The one or more computer-readable storage media of claim 1, wherein the method further comprises identifying one or more secondary entities that are related to the at least one related entity, and wherein altering the initial confidence score for at least one of the two or more entity categories of which the target entity is a member further comprises altering the initial confidence score for at least one of the two or more entity categories of which the target entity is a member based upon entity categories of which the one or more secondary entities is a member.

6. The one or more computer-readable storage media of claim 1, wherein the method further comprises assigning a single dominant entity category to the target entity based on the altered initial confidence scores.

7. The one or more computer-readable storage media of claim 6, wherein assigning the single dominant entity category to the target entity comprises rule-based entity category mapping.

8. A method being performed by one or more computing devices including at least one processor, the method for identifying dominant entity categories associated with target entities, the method comprising:
receiving a target entity;
utilizing multiple data sources, at least one of which includes information pertaining to a plurality of entities arranged in a graph-based ontology, the information including entity categories of which each of the plurality of entities respectively is a member:
determining that the target entity is a member of two or more of the plurality of entity categories; and
assigning an initial confidence score for the target entity to each of the two or more entity categories of which the target entity is a member, each initial confidence score representing a likelihood that the respective entity category is dominant for the target entity;
identifying at least one related entity that is closely related to the target entity;
determining at least one entity category of the plurality of entity categories of which the at least one related entity is a member; and
altering the initial confidence score for at least one of the two or more entity categories of which the target entity is a member based upon at least one correlation between the two or more entity categories of which the target entity is a member and the at least one entity category of which the at least one related entity is a member.

9. The method of claim 8, wherein the at least one data source which includes the plurality of entity categories is organized as a graph-based ontology.

10. The method of claim 9, wherein altering the initial confidence score for at least one of the two or more entity categories of which the target entity is a member based upon at least one correlation between the two or more entity categories of which the target entity is a member and the at least one entity category of which the at least one related entity is a member comprises altering the initial confidence score based upon graph-based confidence score propagation.

11. The method of claim 10, wherein the graph-based confidence score propagation further includes determining the target entity enjoys one or more accolades commonly associated with a certain entity category of the two or more entity categories of which the target entity is a member and altering the initial confidence score for the certain entity category accordingly.

12. The method of claim 8, further comprising identifying one or more secondary entities that are related to the at least one related entity, wherein altering the initial confidence score for at least one of the two or more entity categories of which the target entity is a member further comprises altering the initial confidence score for at least one of the two or more entity categories of which the target entity is a member based upon entity categories of which the one or more secondary entities is a member.

13. The method of claim 8, further comprising assigning a single dominant entity category to the target entity based on the altered confidence scores.

14. The method of claim 13, wherein assigning the single dominant entity category to the target entity comprises rule-based entity category mapping.

15. A system comprising:
a search engine having one or more processors and one or more computer-readable storage media;
a first data source coupled with the search engine, the first data source including a plurality of entities associated therewith, each having at least one associated entity category; and
a second data source coupled with the search engine,
wherein the search engine:
receives a target entity;
utilizing the first and second data sources:
determines that the target entity is a member of two or more of the plurality of entity categories; and
assigns an initial confidence score for the target entity to each of the two or more entity categories of which the target entity is a member, each initial confidence score representing a likelihood that the respective entity category is dominant for the target entity;
identifies at least one related entity that is closely related to the target entity;
determines, by performing graph-based confidence score propagation, a correlation between the two or more entity categories of which the target entity is a member and at least one entity category of which the at least one related entity is a member; and
alters the initial confidence score for at least one of the two or more entity categories of which the target entity is a member based upon the correlation.

16. The system of claim 15, wherein information pertaining to the plurality of entities, including the associated entity categories, is organized in the first data source as a graph-based ontology.

17. The system of claim 15, wherein the search engine further utilizes the graph-based confidence score propagation to determine that the target entity enjoys one or more accolades commonly associated with a certain entity category of the two or more entity categories of which the target entity is a member and alters the initial confidence score for the certain entity category accordingly.

18. The system of claim 15, wherein the search engine further identifies one or more secondary entities that are related to the at least one related entity and alters the initial confidence score for at least one of the two or more entity categories of which the target entity is a member based upon entity categories of which the one or more secondary entities is a member.

19. The system of claim 15, wherein the search engine further assigns a single dominant entity category to the target entity based on the altered confidence scores.

20. The system of claim 19, wherein the search engine assigns the single dominant entity category to the target entity based upon rule-based entity category mapping.
